(19) United States
(12) Patent Application Publication
(10) Pub. No.: US 2011/0221872 A1
(43) Pub. Date: Sep. 15, 2011

(54) Image display device and method of displaying image

(75) Inventor: Kensuke Motomura, Kanagawa (JP)

(73) Assignee: Sony Corporation, Tokyo (JP)

(21) Appl. No.: 12/932,660

(22) Filed: Mar. 2, 2011

(30) Foreign Application Priority Data
Mar. 9, 2010 (JP) P2010-051414

(51) Int. Cl. H04N 13/04

(52) U.S. Cl. 348/51; 348/E13.075

(57) ABSTRACT

An image display device includes: an image display section; a display controller alternately displaying left and right eye images, which have parallax therebetween, on the image display section; a synchronizing signal generating section generating a synchronizing signal indicating a display timing of each of the left and right eye images on the image display section, as an internal synchronizing signal; a synchronizing signal receiver receiving a synchronizing signal indicating the display timing of each of the left and right eye images output from another image display device, as an external synchronizing signal; and a synchronizing signal selecting section selecting either the external synchronizing signal or the internal synchronizing signal output from the synchronizing signal generating section, as a reference synchronizing signal, when the synchronizing signal receiver receives the external synchronizing signal.

### BACKGROUND OF THE INVENTION

1. Field of the Invention

The present invention relates to an image display device and a method of displaying an image, and more particularly, to an image display device or the like that alternately displays a left eye image and a right eye image, which have parallax therebetween, to enable a viewer to perceive a three-dimensional image.

2. Description of the Related Art

In the related art, as a method of displaying a three-dimensional image, a shutter eyeglasses type has been known. In this shutter eyeglasses type, a left eye image and a right eye image, which have parallax therebetween, are alternately displayed on a display (image display section) of the image display device and a viewer views the displayed images through shutter eyeglasses, such that the viewer can perceive three-dimensional images (for example, see Japanese Unexamined Patent Application Publication Nos. 2002-209232, 08-275207 and 2003-168136).

In this case, a synchronizing signal indicating the display timing of each of the left eye image and the right eye image is output from the image display device. The shutter eyeglasses open a left eye shutter at a timing when the left eye image is displayed and opens a right eye shutter at a timing when the right eye image is displayed, based on the synchronizing signal.

### SUMMARY OF THE INVENTION

Hereinafter, environments where the left eye image and the right eye image, which have parallax therebetween as described above, are alternately displayed on a plurality of image display devices and a viewer views the displayed images simultaneously can be supposed. For example, an environment where a viewer views in parallel and simultaneously a three-dimensional image presented by a television receiver (TV) and a three-dimensional image presented by a personal computer (PC) can be considered.

In this case, it is necessary that the display timing of each of the left eye image and the right eye image displayed on each display of the image display devices is synchronized for viewing the three-dimensional image presented by each of the image display devices using one pair of shutter eyeglasses.

It is desirable to view a three-dimensional image presented by a plurality of displays using one pair of shutter eyeglasses.

According to one embodiment of the invention, there is provided an image display device including an image display section; a display controller that alternately displays a left eye image and a right eye image, which have parallax therebetween, on the image display section; a synchronizing signal generating section that generates a synchronizing signal indicating the display timing of each of the left eye image and the right eye image on the image display section, as an internal synchronizing signal; a synchronizing signal receiver that receives a synchronizing signal indicating the display timing of each of the left eye image and the right eye image output from another image display device, as an external synchronizing signal; and a synchronizing signal selecting section that selects either the external synchronizing signal or the internal synchronizing signal output from the synchronizing signal generating section, as a reference synchronizing signal, when the synchronizing signal receiver receives the external synchronizing signal, in which the display controller alternately displays the left eye image and the right eye image on the image display section at the display timing based on the reference synchronizing signal selected in the synchronizing signal selecting section.

In this embodiment, the left eye image and the right eye image, which have parallax therebetween, are alternately displayed on the image display section by the display controller. When the synchronizing signal receiver receives a synchronizing signal indicating the display timing of each of the left eye image and the right eye image output from another image display device as an external synchronizing signal, the synchronizing signal selecting section selects either the external synchronizing signal or the internal synchronizing signal as the reference synchronizing signal. The display controller alternately displays the left eye image and the right eye image on the image display section at a display timing based on the reference synchronizing signal selected by the synchronizing signal selecting section. A communication type of the synchronizing signal receiver may be, for example, either one of an infrared (IR) communication type or a radio communication type.

In this embodiment, for example, the synchronizing signal selecting section may determine each of the frequency and the signal format based on the external synchronizing signal and the internal synchronizing signal, and selects the external synchronizing signal as the reference synchronizing signal in a case where the frequency and the signal format based on the external synchronizing signal are faster than the frequency and the signal format based on the internal synchronizing signal. The synchronizing signal selecting section may select either the external synchronizing signal or the internal synchronizing signal as the reference synchronizing signal, in a case where the frequency and the signal format based on the external synchronizing signal are equal to the frequency and the signal format based on the internal synchronizing signal. The synchronizing signal selecting section may select the internal synchronizing signal as the reference synchronizing signal in all other cases.

In this embodiment, for example, the synchronizing signal selecting section may select either the external synchronizing signal or the internal synchronizing signal as the reference synchronizing signal based on an acquisition state of the external synchronizing signal when the power is switched ON or on the user's selection operation.

In this embodiment, for example, a user setting section that selectively sets a master mode, a slave mode, an auto mode, or a manual mode may be further provided. The synchronizing signal selecting selection may select the internal synchronizing signal as the reference synchronizing signal, when the master mode is selected by the user setting section. The synchronizing signal selecting section may select the external synchronizing signal as the reference synchronizing signal, when the slave mode is selected by the user setting section. When the auto mode is selected by the user setting section, the synchronizing signal selecting section may determine each of the frequency and the signal format based on the external synchronizing signal and the internal synchronizing signal and may select the external synchronizing signal as the reference synchronizing signal, in a case where the frequency and the signal format based on the external synchronizing signal are faster than the frequency and the signal format based on the internal synchronizing signal. The synchronizing signal selecting section may select either the external synchronizing signal or the internal synchronizing signal as the reference synchronizing signal, in a case where the frequency and the signal format based on the external synchronizing signal are equal to the frequency and the signal format based on the internal synchronizing signal. The synchronizing signal may select the internal synchronizing signal as the reference synchronizing signal in other cases. The synchronizing signal selecting section may select either the external synchronizing signal or the internal synchronizing signal according to the user's selection operation, when the manual mode is selected by the user setting section.

The frequency or the signal format of the external synchronizing signal and the internal synchronizing signal may be, for example, a format related to a display timing cycle, a resolution or a frame rate, interlaced/progressive, or a timing of a video signal of each of the left eye image and the right eye image, may be exemplified by 480i, 480p, 1080i, 720p, 1080p, VGA, SVGA, XGA, WXGA, SXGA, UXGA, 30 frames/second, 60 frames/second, 90 frames/second, 120 frames/second, 240 frames/second, 480 frames/second (i: interlaced, p: progressive) or the like.

In this embodiment, for example, a synchronizing signal transmitter that generates a synchronizing signal for transmission based on the internal synchronizing signal or the reference synchronizing signal selected by the synchronizing signal selecting section and transmits the synchronizing signal for transmission to another image display device and a three-dimensional image observing shutter eyeglasses may be further provided. A communication type of the synchronizing signal transmitter may be, for example, either one of an IR communication type or a radio communication type.

As described above, when the external synchronizing signal (synchronizing signal indicating the display timing of each of the left eye image and the right eye image output from another image display device) is received, the external synchronizing signal or the internal synchronizing signal may be selected as the reference synchronizing signal, and the left eye image and the right eye image may be alternately displayed on the image display section at a display timing based on the selected reference synchronizing signal. In addition, when the internal synchronizing signal is selected as the reference signal, the synchronizing signal for transmission based on the internal synchronizing signal may be transmitted from the synchronizing signal transmitter. In another image display device, the synchronizing signal for transmission may be received as the external synchronizing signal and the left eye image and the right eye image may be alternately displayed at a display timing based on the external synchronizing signal.

In this embodiment, for example, the synchronizing signal selecting section may determine each of the frequency and the signal format based on the external synchronizing signal and the internal synchronizing signal, and may synchronize with the display timing based on the reference synchronizing signal when the frequency and the signal format based on the reference synchronizing signal selected from the external synchronizing signal or the internal synchronizing signal are not a frequency and a signal format capable of being displayed on the image display section. In addition, the synchronizing signal selecting section may convert or adjust the frequency and the signal format of the reference synchronizing signal to be a frequency and signal format capable of being displayed on the image display section, and outputs the converted or adjusted reference synchronizing signal. In this case, even when the frequency and the signal format based on the reference synchronizing signal selected from the external synchronizing signal or the internal synchronizing signal are not a frequency and a signal format capable of being displayed on the image display section, the synchronizing signal selecting section may output an appropriate reference synchronizing signal corresponding to the frequency and the signal format capable of being displayed on the display section.

Therefore, the display timing of each of the left eye image and the right eye image, which are alternately displayed on the image display section of each of the image display devices, may be synchronized. Thus, it is possible to view three-dimensional images presented by a plurality of image display device using one pair of shutter eyeglasses for viewing the three-dimensional images.

In this embodiment, for example, the synchronizing signal transmitter may stop the transmission of the synchronizing signal, when the external synchronizing signal is selected as the reference synchronizing signal by the synchronizing signal selecting section. In this case, the shutter eyeglasses may perform a shutter operation by only receiving the synchronizing signal transmitted from another image display device. Therefore, malfunctions caused by the reception of the synchronizing signals transmitted from a plurality of devices may be prevented.

In this embodiment, an image processing section that inputs the left eye image signal and the right eye image signal may be further provided. The image processing section may perform a conversion processing of a signal format based on the reference synchronizing signal with respect to the left eye image signal and the right eye image signal that are input. In addition, the image processing section may synchronize the left eye image signal and the right eye image signal after the conversion processing, with the display timing based on the synchronizing signal and outputs the synchronized signals to the display controller.

According to the invention, since the display timing of each of the left eye image and the right eye image, which are alternately displayed on the image display section of each of the image display devices, is synchronized, it is possible to view three-dimensional images presented by a plurality of image display devices using one pair of shutter eyeglasses for viewing the three-dimensional images.

### BRIEF DESCRIPTION OF THE DRAWINGS

FIG. 1 is a block diagram illustrating a configuration example of an image display observation system according to an embodiment of the invention;

FIG. 2 is a schematic diagram illustrating a three-dimensional image display operation in the image display observation system;

FIG. 3 is a block diagram illustrating a configuration example of a television receiver making up the image display observation system;

FIG. 4 is a block diagram illustrating a synchronizing signal processing section of the television receiver, which includes a resolution determining section, a switch section, and a reference synchronizing signal adjusting section;

FIG. 5 is a flowchart illustrating a processing sequence of a processing mode determining operation of a CPU and a determining operation of a synchronization selecting process of the switch section;

FIG. 6 is a view illustrating an example of an UI screen displayed on a display when a user sets (changes) a processing mode;

FIG. 7 is a flowchart illustrating a subroutine processing when it is set (changed) to a manual mode;

FIG. 8 is a view illustrating an example of an UI screen for a synchronization processing selection in a manual mode;

FIG. 9 is a flowchart illustrating a subroutine processing when it is set (changed) to an auto mode;

FIG. 10 is a block diagram illustrating a configuration example of a personal computer that makes up the image display observation system;

FIG. 11 is a block diagram illustrating a configuration example of shutter eyeglasses;

FIG. 12 is a block diagram illustrating another configuration example of the image display observation system;

FIG. 13 is a block diagram illustrating another configuration example of shutter eyeglasses;

FIG. 14 is a timing chart illustrating the timing of image data and a reference synchronizing signal; and

FIG. 15 is a timing chart illustrating a method of generating a reference synchronizing signal capable of being displayed by a personal computer 200 from an external synchronizing signal.

### DESCRIPTION OF THE PREFERRED EMBODIMENTS

Hereinafter, an embodiment of the invention (hereinafter, referred to as “embodiment”) will be described. In addition, descriptions will be made in the following order.

1. Embodiment

2. Modification 1

3. Modification 2

### 1. Embodiment

### Configuration Example of Image Display Observation System

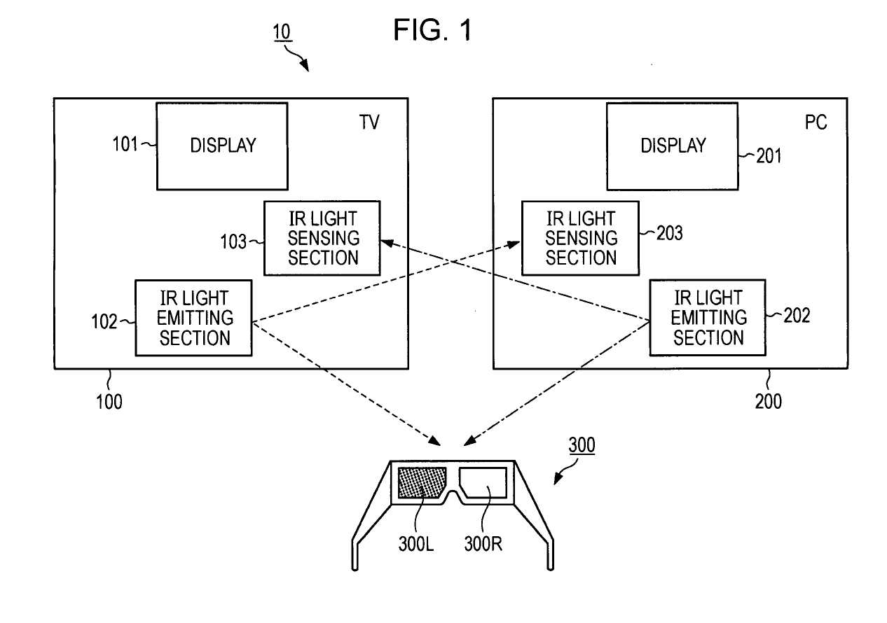

FIG. 1 shows a configuration example of an image display observation system 10 according to an embodiment of the invention. The image display observation system 10 includes a television receiver (TV) 100, a personal computer (PC) 200 and shutter eyeglasses 300.

The television receiver 100 includes a display 101, an infrared (IR) light emitting section 102 and an IR light sensing section 103. A left eye image and a right eye image, which have parallax therebetween, are alternately displayed on the display 101. The IR light emitting section 102 outputs a synchronizing signal representing the display timing of each of the left eye image and the right eye image on the display 101 as an IR signal.

The IR light sensing section 103 receives, as an external synchronizing signal, a synchronizing signal (IR signal) output from another image display device, that is, a personal computer 200 in this embodiment. The television receiver 100 selects either the external synchronizing signal or an internal synchronizing signal when the external synchronizing signal is received from the IR light sensing section 103. In the television receiver 100, the left eye image and the right eye image are alternately displayed on the display 101 at a display timing based on the selected synchronizing signal.

The personal computer 200 includes a display 201, an IR light emitting section 202, and an IR light sensing section 203. A left eye image and a right eye image, which have parallax therebetween, are alternately displayed on the display 201. The IR light emitting section 202 outputs a synchronizing signal representing the display timing of each of the left eye image and the right eye image on the display 201 as an IR signal.

The IR light sensing section 203 receives, as an external synchronizing signal, a synchronizing signal (IR signal) output from another image display device, that is, the television receiver 100 in this embodiment. The personal computer 200 selects either the external synchronizing signal or an internal synchronizing signal when the external synchronizing signal is received from the IR light sensing section 203. In the personal computer 200, the left eye image and the right eye image are alternately displayed on the display 201 at a display timing based on the selected synchronizing signal.

Herein, when the external synchronizing signal (synchronizing signal output from the television receiver 100) is selected in the personal computer 200, the internal synchronizing signal is selected in the television receiver 100. On the other hand, when the internal synchronizing signal is selected by the personal computer 200, the external synchronizing signal (synchronizing signal output from the personal computer 200) is selected in the television receiver 100. In this case, the synchronization in the display timing of each of the left eye image and the right eye image displayed on each of the display 101 of the television receiver 100 and the display 201 of the personal computer 200 is made.

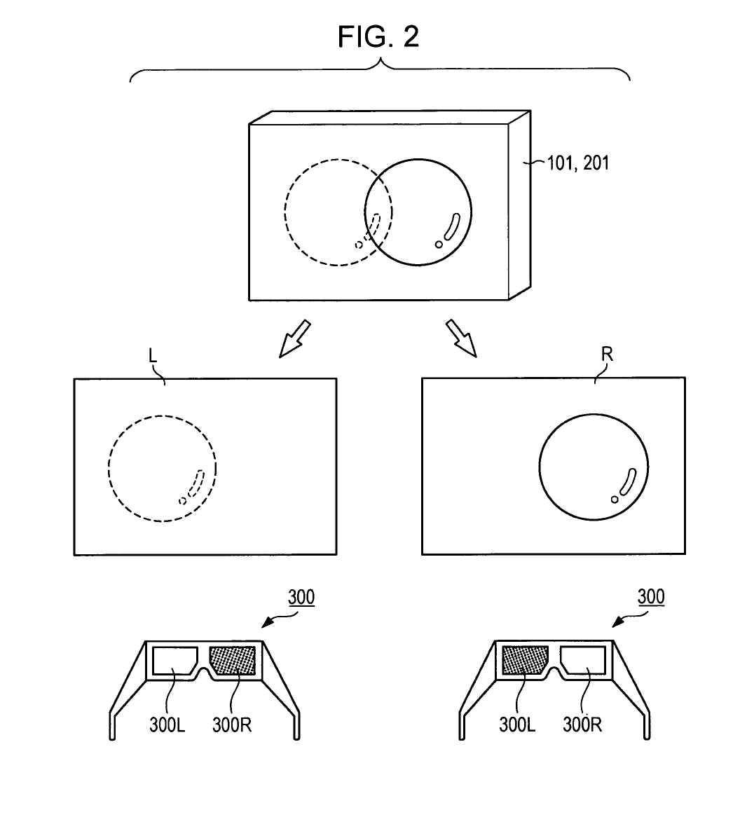

FIG. 2 shows schematically an operation in the image display observation system 10 shown in FIG. 1. In the three-dimensional image observing shutter eyeglasses 300, a left eye shutter 300L opens at a timing when the left eye image L is displayed on the displays 101 and 201 and a right eye shutter 300R opens at a timing when the right eye image R is displayed on the displays 101 and 201. Therefore, when a viewer wears the shutter eyeglasses 300, the viewer can perceive only the left eye image L with the left eye and can perceive only the right eye image R with the right eye. By this, the viewer can perceive the image three-dimensionally based on the left eye image L and the right eye image R, which have parallax therebetween.

As described above, the synchronization in the display timing of each of the left eye image and the right eye image displayed on each of the display 101 of the television receiver 100 and the display 201 of the personal computer 200 is made. Therefore, it is possible to view three-dimensional images presented by the television receiver 100 and the personal computer 200 using one pair of shutter eyeglasses 300.

### [Configuration of Television Receiver]

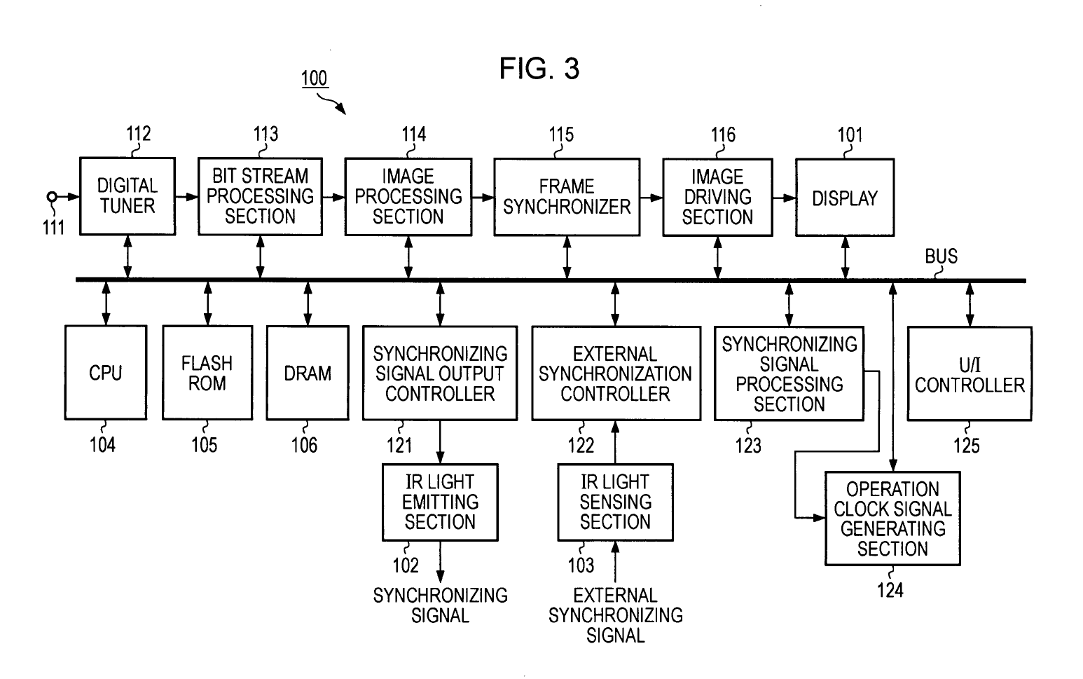

A configuration of the television receiver 100 will be described. FIG. 3 shows a configuration example of the television receiver 100. The television receiver 100 includes a display 101, an infrared (IR) light emitting section 102, an infrared (IR) sensing section 103, a CPU 104, a flash ROM 105, and a DRAM 106.

In addition, the television receiver 100 includes an antenna terminal 111, a digital tuner 112, a bit stream processing section 113, an image processing section 114, a frame synchronizer 115, and an image driving section 116. In addition, the television receiver 100 includes a synchronizing signal output controller 121, an external synchronization controller 122, a synchronizing signal processing section 123, an operation clock signal generating section 124, and an U/I controller 125. Each block described above making up the television receiver 100 connects to each other via a bus.

Here, the display 101 makes up an image display section. In addition, the image processing section 114, the frame synchronizer 115, and the image driving section 116 make up a display controller. In addition, the synchronizing signal output controller 121 and the IR light emitting section 102 make up a synchronizing signal transmitter. In addition, the IR light sensing section 103 and the external synchronization controller 122 make up a synchronizing signal receiver. In addition, the synchronizing signal processing section 123 and the CPU 104 make up a synchronizing signal selecting section.

The CPU 104 controls the operation of each section of the television receiver 100. The flash ROM 105 stores the control software and data. The DRAM 106 makes up a work area of the CPU 104. The CPU 104 lays out the software or the data read from the flash ROM 105 on the DRAM 106 and activates the software to control each section of the television receiver 100.

The U/I controller 125 receives an operation signal corresponding to a user's operation from a remote controller (not shown) remotely controlling the television receiver 100 and supplies the operation signal to the CPU 104 via the bus. In addition, the U/I controller 125 receives an operation signal input by the operation of an operation button provided at an operation panel (not shown) of the television receiver 100 by a user and supplies the operation signal to the CPU 104 via the bus. As the operation signal, for example, signals indicating the power ON or power OFF of the television receiver 100, a channel tuning by the digital tuner 112, an image-related process, a audio-related process, and other various processes can be exemplified.

The antenna terminal 111 is a terminal that inputs a television broadcast signal received by a receiving antenna (not shown). The Digital tuner 112 processes the television broadcast signal input to the antenna terminal 111 and outputs bit stream data corresponding to a channel selected by a user. The bit stream processing section 113 extracts, for example, image data (left eye image data and right eye image data) as contents data for three-dimensional images and audio data from the bit stream data and outputs the extracted data. In addition, the bit stream processing section 113 outputs an internal synchronization signal indicating a display timing or a signal format of the image data. In addition, in the configuration example of the television receiver 100 shown in FIG. 3, a audio-related configuration is omitted for simplicity of explanation.

The image processing section 114 performs a scaling processing in a time direction and other image processing with respect to the image data output from the bit stream processing section 113. In addition, the image processing section 114 performs a decoding process when the image data output from the bit stream processing section 113 is encoded using an MPEG (Moving Picture Expert Group) method or other methods.

The frame synchronizer 115 synchronizes the image data that is scaling-processed by the image processing section 114 with the display timing of each of the left eye image and the right eye image based on a reference synchronizing signal described later and outputs the synchronized image data. The image driving section 116 drives the display 101 based on each frame image data (left eye image data and right eye image data) output from the frame synchronizer 115. The display 101 alternately displays the left eye image L and right eye image R, which have parallax therebetween. The display 101 includes, for example, an LCD (Liquid Crystal Display), an organic EL (Electro-Luminescence), or the like.

The synchronizing signal output controller 121 supplies a driving signal to the IR light emitting section 102 based on a timing signal representing the display timing and a signal format of each of the left eye image L and the right eye image R on the display 101 or the like. The IR light emitting section 102 emits a light according to the driving signal and outputs a synchronizing signal representing the display timing of each of the left eye image L and the right eye image R to the display 101 as an IR signal.

The IR light sensing section 103 receives an external synchronizing signal (IR signal). The external synchronization controller 122 acquires the external synchronizing signal received by the IR light sensing section 103. As described above, the external synchronizing signal is a signal representing the display timing and a signal format of each of the left eye image L and the right eye image R output from the personal computer 200 and then displayed on the display 201, or the like.

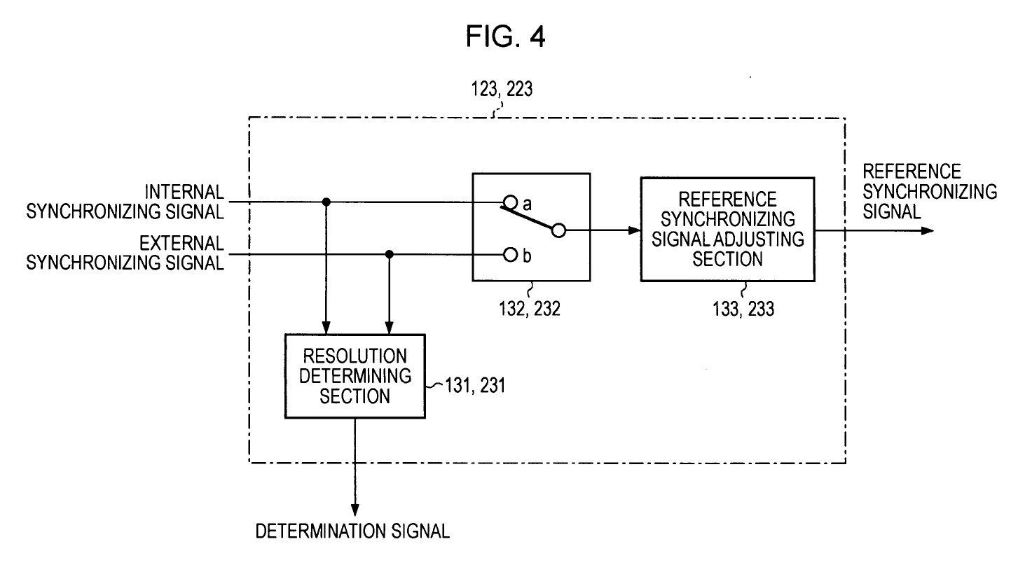

As shown in FIG. 4, the synchronizing signal processing section 123 includes a resolution determining section 131, a switch section 132, and a reference synchronizing signal adjusting section 133. The internal synchronizing signal output from the bit stream processing section 113 and the external synchronizing signal acquired at the external synchronization controller 122 are input to the resolution determining section 131. The resolution determining section 131 determines the display timing, the frequency, the signal format or the like of each of the left eye image L and the right eye image R based on each synchronizing signal. The synchronizing signal processing section 123 informs the CPU 104 of the determining signal obtained in the resolution determining section 131.

The switch section 132 selectively takes out the internal synchronizing signal or the external synchronizing signal under the control of the CPU 104 and outputs the taken-out signal as a reference synchronizing signal. Hereinafter, the processing where the switch section 132 selects the internal synchronizing signal as the reference synchronizing signal is referred to as “master synchronization processing” and the processing where the switch section 132 selects the external synchronizing signal as the reference synchronizing signal is referred to as “slave synchronization processing”. When the master synchronization processing is performed, the switch section 132 connects to an “a” side and outputs the internal synchronizing signal as the reference synchronizing signal to the reference synchronizing signal adjusting section 133. In addition, when the slave synchronization processing is performed, the switch section 132 connects to a “b” side and outputs the external synchronizing signal as the reference synchronizing signal to the reference synchronizing signal adjusting section 133.

In a case where it is confirmed that the reference synchronizing signal has a display timing, a frequency, and a signal format that can be displayed on the display 101, according to the determination signal obtained in the resolution determining section 131, the reference synchronizing signal is passed through the reference synchronizing signal adjusting section 133, under the control of the CPU 104. On the other hand, in a case where it is confirmed that the reference synchronizing signal does not have a display timing, a frequency, and a signal format that can be displayed on the display 101, the reference synchronizing signal adjusting section 133 adjusts the reference synchronizing signal to have a display timing, a frequency, and a signal format that can be displayed by the display 101, under the control of the CPU 104, and outputs the adjusted signal.

In the CPU 104, the selection of a synchronization processing between a master synchronization processing and a slave synchronization processing by the switch section 132 is determined based on the determination signal obtained in the resolution determining section 131, a processing mode setting by a user, whether or not the external synchronizing signal is acquired or the like. The determining operation of the synchronization selecting process of the switch section 132 in the CPU 104 will be described later.

The operation clock signal generating section 124 generates an operation clock signal synchronized with the phase of the reference synchronizing signal output from the synchronizing signal processing section 123. The image processing section 114, the frame synchronizer 115, the image driving section 116 or the like operates based on the reference synchronizing signal and operation clock signal. Therefore, the display timing of each of the left eye image signal L and the right eye image signal R on the display 101 synchronizes with the reference synchronizing signal.

In addition, the above-described synchronizing signal output controller 121 also operates based on the reference synchronizing signal and operation clock signal. Therefore, the synchronizing signal output controller 121 can operate the IR light emitting section 102 to output a synchronizing signal (IR signal) indicating the display timing and the signal format of the left eye image L and the right eye image R or the like.

### [Processing Mode Determining Operation by CPU]

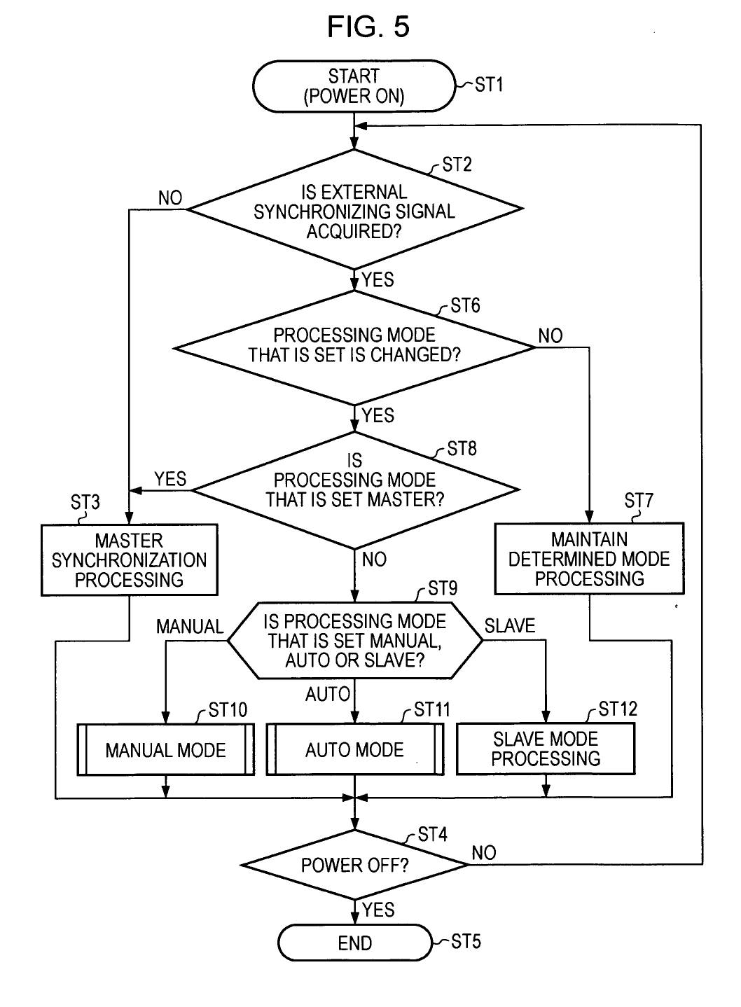

Next, a processing mode determining operation by the CPU 104 and the determining operation of the synchronization selecting process of the switch section 132 will be described. FIG. 5 shows a flowchart illustrating a processing sequence of the processing mode determining operation of the CPU 104 and the determining operation of the synchronization selecting process of the switch section 132.

First, in step ST1, the CPU 104 starts a process at a power ON timing. Then, in step ST2, the CPU 104 determines whether or not an external synchronizing signal is acquired in the external synchronization controller 122. When it is transitioned from step ST1 to step ST2, whether or not an external synchronizing signal is acquired (an acquisition state of the external synchronizing signal at power ON) is stored in the DRAM 106. When it is determined that the external synchronizing signal is not acquired in step ST2, a master synchronization processing is determined by the CPU 104 in step ST3.

After step ST3, in step ST4, the CPU 104 determines whether the power is switched OFF or not. When the power is switched OFF, the CPU 104 terminates the process in step ST5. On the other hand, when the power is not OFF, the CPU 104 returns the process to step ST2.

When it is determined that the external synchronizing signal is acquired in step ST2, the CPU 104 moves the process to step ST6. In step ST6, the CPU 104 determines whether or not the processing mode set by a user is changed.

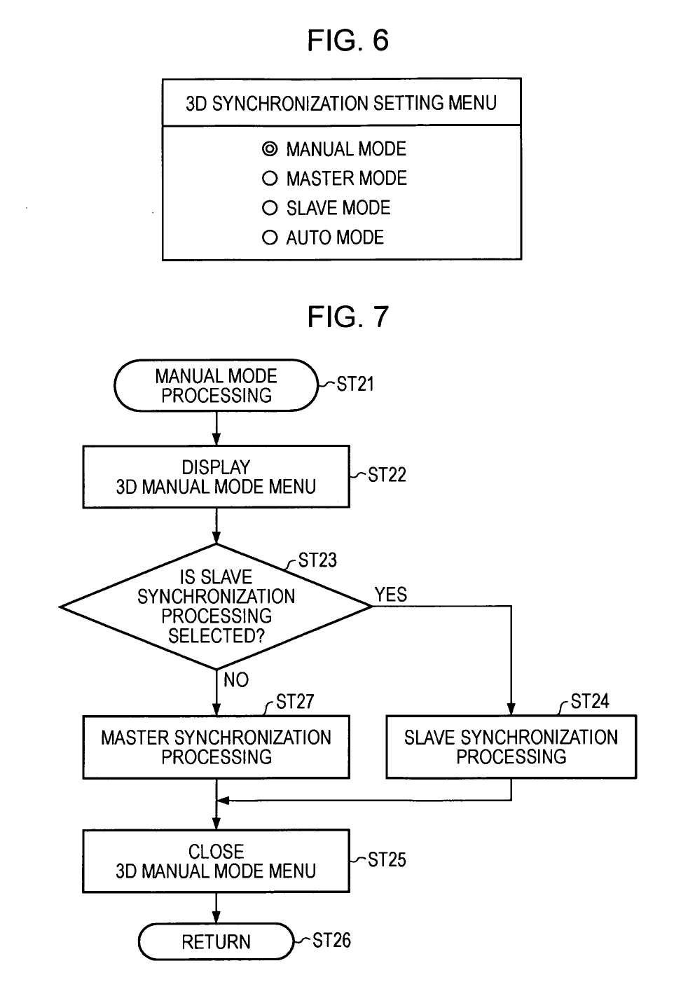

The user can selectively set a master mode, a slave mode, an auto mode or manual mode as the processing mode. When the user sets (changes) the processing mode, for example, a setting UI screen (3D synchronization setting menu) in which a radio button corresponding to each selection item is provided is displayed on the display 101, as shown in FIG. 6. The user can simply set (change) the processing mode using the UI screen.

Returning back to the flowchart in FIG. 5, when it is determined that the processing mode is not changed in step ST6, the CPU 104 maintains the master synchronization processing or the slave synchronization processing state determined based on the processing mode set by the user as it is, in step ST7. Then, the CPU 104 moves the process to step ST4.

When it is determined that the processing mode is changed by the user in step ST6, the CPU 104 moves the process to step ST8. In step ST8, the CPU 104 determines whether the processing mode that is set is the master mode or not. When it is determined as the master mode, the master synchronization processing is determined by the CPU 104 in step ST3 and the process proceeds to step ST4.

In addition, when it is determined that the processing mode is not changed to the master mode in step ST8, the CPU 104 moves the process to step ST9. In step ST9, the CPU 104 determines that the processing mode that is set is any one of the manual mode, the auto mode, or the slave mode.

When the processing mode is determined to be the manual mode, the CPU 104 moves the process to a subroutine processing of the manual mode of step ST10. FIG. 7 shows the subroutine processing of step ST10.

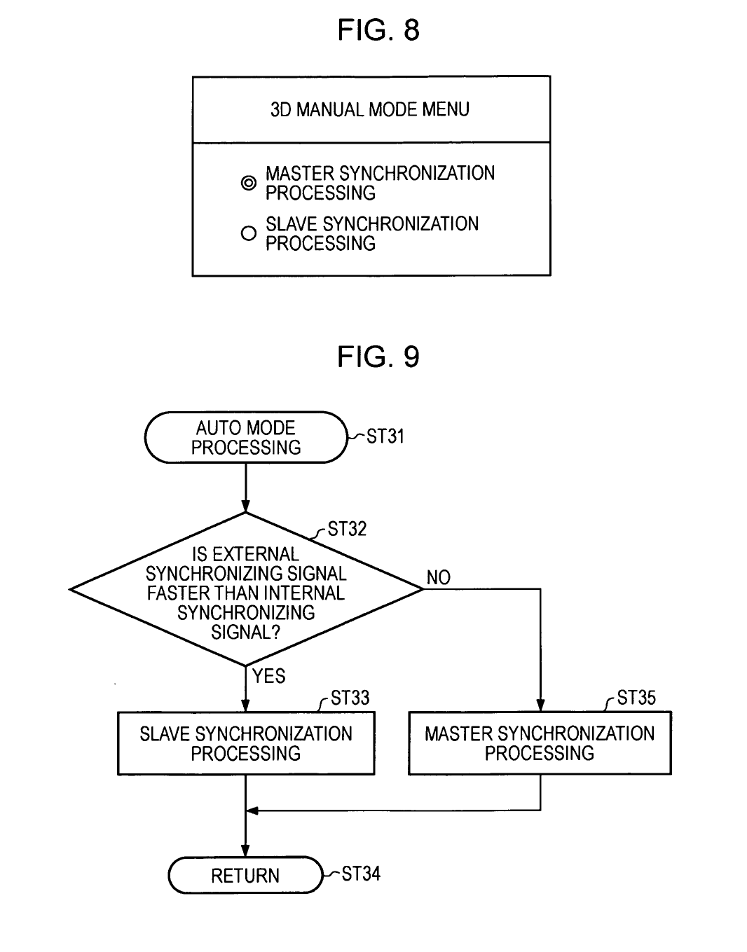

First, in step ST21, the CPU 104 starts the process and then moves the process to step ST22. In step ST22, the CPU 104 displays on the display 101 a UI screen for a synchronizing signal selection in which a radio button corresponding to each selection item is provided, as shown in FIG. 8. The user can simply perform the selection of the master synchronization processing or the slave synchronization processing using the UI screen.

Next, the CPU 104 determines whether or not the slave synchronization processing is selected in step ST23. When the slave synchronization processing is selected, the slave synchronization processing is determined by the CPU 104, in step ST24. Then, the CPU 104 closes the display of the UI screen for the synchronizing signal selection in step ST25 and performs a return in step ST26.

On the other hand, when the slave synchronization processing is not selected in step ST23, that is, the master synchronization processing is selected, the master synchronization processing is determined by the CPU 104, in step ST27. Then, the CPU 104 closes the display of the UI screen for the synchronizing signal selection in step ST25 and performs a return in step ST26.

Returning to the flow chart of FIG. 5, when it is determined as the auto mode in step ST9, the CPU 104 moves the process to a subroutine processing of the auto mode of step ST11. FIG. 9 shows the subroutine processing of step ST11.

First, the CPU 104 starts the process in step ST31 and then moves the process to step ST32. In step ST32, the CPU 104 determines whether or not a display timing, a frequency and a signal format of each of the left eye image L and the right eye image R based on the internal synchronizing signal are faster than a display timing, a frequency and a signal format of each of the left eye image L and the right eye image R based on the external synchronizing signal, or whether they are equal to each other, based on the determination signal obtained in the resolution determining section 131 of the synchronizing signal processing section 123. For example, when a frame rate as the display timing of each of the left eye image L and the right eye image R based on the internal synchronization signal is 60 frames/second and a frame rate as the display timing of each of the left eye image L and the right eye image R based on the external synchronization signal is 240 frames/second, the CPU 104 determines that the external synchronizing signal is faster than the internal synchronizing signal.

When the external synchronizing signal is faster than the internal synchronizing signal, the CPU 104 transitions from step ST32 to step. ST33. In step ST33, the slave synchronization processing is determined by the CPU 104. Then, the CPU 104 performs a return in step ST34. On the other hand, in step ST32, when it is determined that a display timing, a frequency and a signal format of each of the left eye image L and the right eye image R based on the internal synchronizing signal is equal to a display timing, a frequency and a signal format of each of the left eye image L and the right eye image R based on the external synchronizing signal, the CPU 104 performs the determination depending on, for example, an acquisition state of the external synchronizing signal at power ON, which is stored in the DRAM 106.

In this case, when transitioning from step ST1 to step ST2, in a case where the external synchronizing signal is not acquired at power ON, the process transitions from step ST32 to step ST35 and the master synchronization processing is determined by the CPU 104 in step ST35. Then, a return is performed in step ST34. In a case where the external synchronizing signal is acquired at power ON, the process transitions from step ST32 to step ST33, the slave synchronization processing is determined by the CPU 104 in step ST33. Then a return is performed in step ST34. In addition, in step ST32, it is determined that the external synchronizing signal is slower than the internal synchronizing signal, the master synchronization processing is determined by the CPU 104 in step ST35, and a return is performed in step ST34.

Returning to the flow chart of FIG. 5, when it is determined as the slave mode in step ST9, the slave synchronization processing is determined as the slave mode processing in step ST12 and then the process proceeds to step ST4.

As described above, the processing mode set by the user, or the master synchronizing processing or slave synchronizing processing as the synchronization selecting process of the switch section 132 is determined.

### [Operation of Television Receiver]

Hereinafter, the operation of the television receiver 100 shown in FIG. 3 will be described. Television broadcast signal input to the antenna terminal 111 is supplied to the digital tuner 112. The television broadcast signal is processed in the digital tuner 112, such that a predetermined bit stream data corresponding to a user's selection channel can be obtained.

The bit stream data output from the digital tuner 112 is supplied to the bit stream processing section 113. In the bit stream processing section 113, image data (left eye image data and right eye image data), audio data, or the like is extracted from the bit stream data and is output. In addition, the internal synchronizing signal is output from the bit stream processing section 113.

The image data output from the bit stream processing section 113 is supplied to the image processing section 114. In the image processing section 114, a scaling processing in a time direction and a signal format conversion such as a frame rate conversion and an I/P conversion are performed with respect to the image data supplied from the bit stream processing section 113, based on the determination signal and the reference synchronizing signal obtained in the synchronizing signal processing section 123, so as to have the same timing frequency as that of the display timing of each of the left eye image L and the right eye image R, which is based on the reference synchronizing signal output from the synchronizing signal processing section 123.

For example, it is assumed that the frame rate of the image data from the bit stream processing section 113 is frames/second and the frame rate based on the reference synchronizing signal output from the synchronizing signal processing section 123 is 120 frames/second, based on the determination signal and the reference synchronizing signal obtained in the synchronizing signal processing section 123. In this case, in the image processing section 114, the frame rate conversion process (format conversion process) from 60 frames/second to 120 frames/second is performed with respect to the image data.

The image data that has undergone the signal format conversion process is supplied to the frame synchronizer 115. The frame synchronizer 115 outputs the image data that has undergone the signal format conversion process in synchronization with the display timing of each of the left eye image and the right eye image, which is based on the reference signal. An example of outputting the image data in synchronization with the reference synchronization signal is described, for example, in Japanese Unexamined Patent Application Publication No. 2004-23134. Each of the frame image data (left eye image data and right eye image data) output from the frame synchronizer 115 is supplied to the image driving section 116.

The display 101 is driven by the image driving section 116 based on each of the frame image data (left eye image data and right eye image data) supplied from the frame synchronizer 115. Therefore, the left eye image L and the right eye image R, which have parallax therebetween, are alternately displayed on the display 101.

In addition, the IR light sensing section 103 receives the external synchronizing signal (IR signal). The external synchronizing signal received by the IR light sensing section 103 as described above is supplied to the external synchronization controller 122. The CPU 104 determines the selection of synchronization processing by the switch section 132 as the master synchronization processing or the slave synchronization processing, based on the determination signal obtained in the resolution determining section 131, the processing mode setting by a user, whether or not the external synchronizing signal is acquired or the like (see FIG. 5).

In a case of the slave synchronization processing, the switch section 132 of the synchronizing signal processing section 123 (see FIG. 4) connects to the “b” side, such that the external synchronizing signal can be obtained as the reference synchronizing signal. The operation clock signal generating section 124 generates an operation clock signal synchronized with the phase of the external synchronizing signal.

Thus, the image processing section 114, the frame synchronizer 115, the image driving section 116, or the like operates based on the operation clock signal synchronized with the external synchronizing signal and the phase thereof. Therefore, the display timing of each of the left eye image signal L and the right eye image signal R on the display 101 synchronizes with the external synchronizing signal.

In addition, in a case of the master synchronization processing, the switch section 132 of the synchronizing signal processing section 123 (see FIG. 4) connects to the “a” side, such that the internal synchronizing signal can be obtained as the reference synchronizing signal. The operation clock signal generating section 124 generates an operation clock signal synchronized with the phase of the internal synchronizing signal.

Thus, the image processing section 114, the frame synchronizer 115, the image driving section 116, or the like operates based on the operation clock signal synchronized with the internal synchronizing signal and the phase thereof. Therefore, the display timing of each of the left eye image signal L and the right eye image signal R on the display 101 synchronizes with the internal synchronizing signal. In addition, in a case of the master mode processing, when the image data input to the frame synchronizer 115 is already in synchronization with the internal synchronizing signal, the function of the frame synchronizer 115 may be off for power saving.

In addition, the reference synchronizing signal and the operation clock signal are supplied to the synchronizing signal output controller 121. Therefore, a driving signal is supplied from the synchronizing signal output controller 121 to the IR light emitting section 102, based on a timing signal indicating the display timing of each of the left eye image L and the right eye image R displayed on the display 101 and the signal format of the reference synchronizing signal. Therefore, a synchronizing signal representing the display timing and the signal format of each of the left eye image L and the right eye image R are output as an IR signal from the IR light emitting section 102.

In addition, in a state where the slave synchronization processing is performed, for example, when the power of an external image display device is switched OFF and therefore the external synchronizing signal is not acquired in the IR light sensing section 103, even as any processing mode may be set, the master synchronization processing is performed (see FIG. 5).

### [Configuration of Personal Computer]

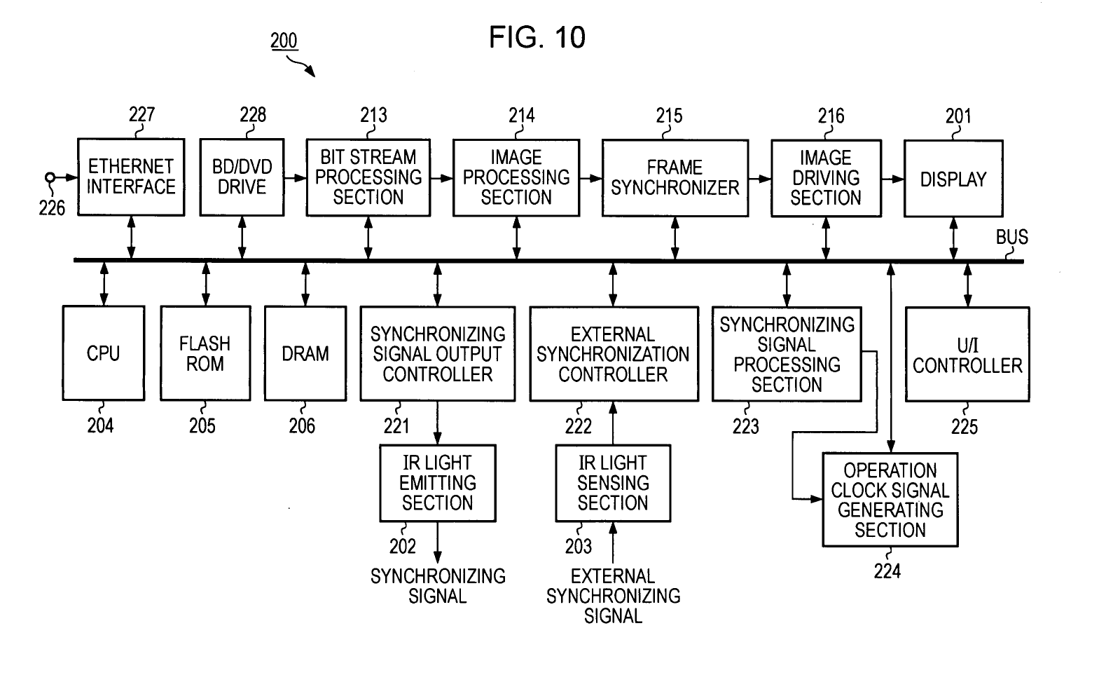

Hereinafter, a configuration of a personal computer 200 will be described. FIG. 10 shows a configuration example of the personal computer 200. The personal computer 200 includes a display 201, an IR light emitting section 202, an IR light sensing section 203, a CPU 204, a flash ROM 205, and a DRAM 206. In addition, the personal computer 200 includes a network terminal 226, an Ethernet interface 227 and, a BD/DVD drive 228. Here, “Ethernet” is a registered trademark.

In addition, the personal computer 200 includes a bit stream processing section 213, an image processing section 214, a frame synchronizer 215, and an image driving section 216. Furthermore, the personal computer 200 includes a synchronizing signal output controller 221, an external synchronization controller 222, a synchronizing signal processing section 223, an operation clock signal generating section 224, and an U/I controller 225. Each block described above making up the personal computer 200 connects to each other via a bus.

Here, the display 201 makes up an image display section. The image processing section 214, the frame synchronizer 215, and the image driving section 216 make up a display controller. The synchronizing signal output controller 221 and the IR light emitting section 202 make up a synchronizing signal transmitter. The IR light receiving section 203 and the external synchronization controller 222 make up a synchronizing signal receiver. The synchronizing signal processing section 223 and the CPU 204 make up a synchronizing signal selecting section.

The CPU 204 controls operation of each section of the personal computer 200. The flash ROM 205 stores control software and data. The DRAM 206 makes up a work area of the CPU 204. The CPU 204 lays out the software or data read from the flash ROM 205 on the DRAM 206 and activates the software to perform the control of each section of the personal computer 200, various operation processes, and the control of the execution of various applications.

The Ethernet interface 227 connects to a network (not shown) such as the internet via a network terminal 226. The Ethernet interface 227, according to a user's operation, receives delivered data (bit stream data) corresponding to the user's selection contents from a contents server (not shown) connected to the network.

The BD/DVD drive 228, according to a user's operation, reproduces a BD or DVD loaded thereon to output reproduction data (bit stream data).

The bit stream processing section 213 extracts image data (left eye image data and right eye image data) and audio data from the above-described delivered data or reproduction data and outputs the extracted data. Furthermore, the bit stream processing section 213 outputs an internal synchronizing signal. The U/I controller 225 receives an operation signal input by operating a keyboard, a mouse, or the like by a user and supplies the operation signal to the CPU 204 via the bus.

Although detailed description will be omitted, the other sections of the personal computer 200 have the same configuration as that of corresponding sections of the television receiver 100 and perform the same operations. In addition, even though a reference numeral is put in parentheses in FIG. 4, as is the case with the synchronizing signal processing section 123 of the television receiver 100, the synchronizing signal processing section 223 includes a resolution determining section 231, a switch section 232, and a reference synchronizing signal adjusting section 233.

As is the case with the CPU 104 of the television receiver 100, in the CPU 204, the selection of a synchronization processing between a master synchronization processing and a slave synchronization processing by the switch section 232 of the synchronizing signal processing section 223 is determined based on the determination signal obtained in the resolution determining section 231 of the synchronizing signal processing section 223, a processing mode setting by a user, whether or not the external synchronizing signal is acquired or the like (see FIG. 5).

In a case of the slave synchronization processing, the switch section 232 of the synchronizing signal processing section 223 connects to the “b” side and outputs the external synchronizing signal as the reference synchronizing signal to the reference synchronizing signal adjusting section 233. In a case where it is confirmed that the reference synchronizing signal has a display timing, a frequency, and a signal format that can be displayed on the display 201, according to the determination signal obtained in the resolution determining section 231, the reference synchronizing signal is passed through the reference synchronizing signal adjusting section 233, under the control of the CPU 204. On the other hand, in a case where it is confirmed that the reference synchronizing signal does not have a display timing, a frequency, and a signal format that can be displayed on the display 201, the reference synchronizing signal adjusting section 233 adjusts the reference synchronizing signal to have a display timing, a frequency, and a signal format that can be displayed by the display 201 and outputs the adjusted signal. An operation process of the reference synchronizing signal adjusting section 233 in the CPU 204 will be described later. The operation clock signal generating section 224 generates an operation clock signal synchronized with the phase of the external synchronizing signal.

Thus, the image processing section 214, the frame synchronizer 215, the image driving section 216, or the like operates based on the operation clock signal synchronized with the external synchronizing signal and the phase thereof. Therefore, the display timing of each of the left eye image signal L and the right eye image signal R displayed on the display 201 synchronizes with the external synchronizing signal.

In addition, in a case of the master synchronization processing, the switch section 232 of the synchronizing signal processing section 223 (see FIG. 4) connects to the “a” side, such that the internal synchronizing signal can be obtained as the reference synchronizing signal. The operation clock signal generating section 224 generates an operation clock signal synchronized with the phase of the internal synchronizing signal.

Thus, the image processing section 214, the frame synchronizer 215, the image driving section 216, or the like operates based on the operation clock signal synchronized with the internal synchronizing signal and the phase thereof. Therefore, the display timing of each of the left eye image signal L and the right eye image signal R displayed on the display 201 synchronizes with the internal synchronizing signal. In addition, in a case of the master mode processing, when the image data input to the frame synchronizer 215 is already in synchronization with the internal synchronizing signal, the function of the frame synchronizer 215 may be turned off for power-saving.

In addition, the reference synchronizing signal and the operation clock signal are supplied to the synchronizing signal output controller 221. Therefore, a driving signal is supplied from the synchronizing signal output controller 221 to the IR light emitting section 202, based on a timing signal representing the display timing of each of the left eye image L and the right eye image R displayed on the display 201 and a signal format of the reference synchronizing signal. Therefore, a synchronizing signal representing the display timing and the signal format each of the left eye image L and the right eye image R is output as an IR signal from the IR light emitting section 202.

### [Configuration of Shutter Eyeglasses]

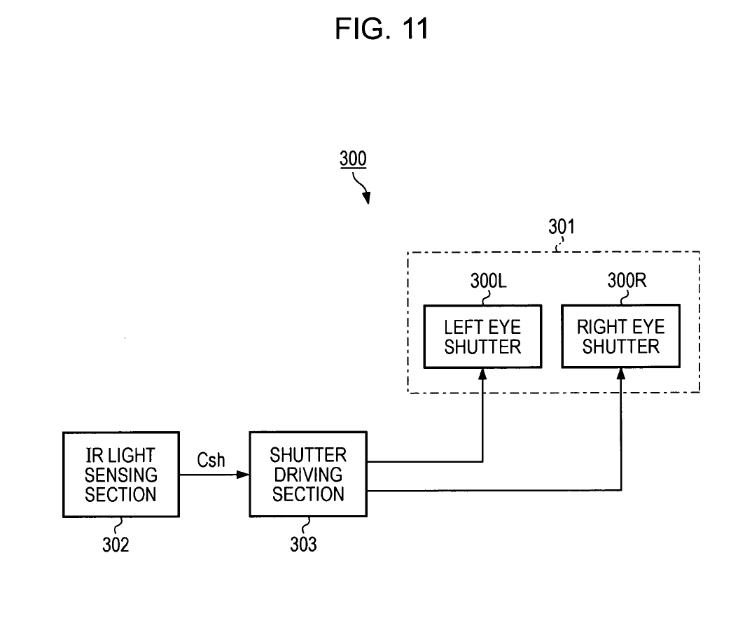

The configuration of the shutter eyeglasses 300 will be described. FIG. 11 shows a configuration example of the shutter eyeglasses 300. The shutter eyeglasses 300 includes an eyeglasses section 301 having a left eye shutter 300L and a right eye shutter 300R, an IR light sensing section 302, and a shutter driving section 303.

The IR light sensing section 302 receives a synchronizing signal (IR signal) representing the display timing of each of the left eye image L and the right eye image R, which is transmitted from, for example, the television receiver 100 or the personal computer 200, as a shutter control signal Csh. The shutter driving section 303 drives the left eye shutter 300L and the right eye shutter 300R of the eyeglasses section 301 based on the shutter control signal Csh received in the IR light sensing section 302.

Specifically, the shutter driving section 303 opens the left eye shutter 300L at a timing when the left eye image L is displayed on the displays 101 and 201. In addition, the shutter driving section 303 opens the right eye shutter 300R at a timing when the right eye image R is displayed on the displays 101 and 201.

The operation of the shutter 300 will be described. The IR light sensing section 302 receives a synchronizing signal (IR signal) representing the display timing of each of the left eye image and the right eye image, which is transmitted from, for example, the television receiver 100 or the personal computer 200, as a shutter control signal Csh. The shutter control signal Csh is supplied to the shutter driving section 303.

In the shutter driving section 303, the driving of the left eye shutter 300L and the right eye shutter 300R making up the eyeglasses section 301 is performed based on the shutter control signal Csh. In this case, the left eye shutter 300L opens at a timing when the left eye image L is displayed on the displays 101 and 201. In addition, the right eye shutter 300R opens at a timing when the right eye image R is displayed on the displays 101 and 201.

The shutter eyeglasses 300 operates as described above, such that when a viewer wears the shutter eyeglasses 300, the viewer can perceive only the left eye image (color image) L with the left eye and perceive only the right eye image (color image) R with the right eye (see FIG. 2). By this, the viewer can perceive a three-dimensional color image based on the left eye image L and the right eye image R, which have parallax therebetween.

As described, with respect to the television receiver 100 and the personal computer 200 making up the image display observation system 10 shown in FIG. 1, the user can selectively set a processing mode among the master mode, the slave mode, the auto mode, or the manual mode.

For example, it is assumed that both of the television receiver 100 and the personal computer 200 are set to auto mode by a user's selection. In this case, for example, when the television receiver 100 is faster than the personal computer 200 in the power ON operation, since the external synchronizing signal is not acquired from the personal computer 200 at the power ON, the master synchronization processing is determined to be performed (see FIG. 5). Thereafter, when the power of the personal computer 200 is switched ON and then the external synchronizing signal is acquired from the personal computer 200, in a case where the frequency of the external synchronizing signal is slower than that of the internal synchronizing signal, the master synchronization processing is determined to be performed (see FIG. 9).

On the other hand, when the external synchronizing signal is acquired from the television receiver 100, if the frequency of the external synchronizing signal is faster than that of the internal synchronizing signal of the personal computer 200, the slave synchronization processing is determined to be performed in the personal computer 200 (see FIG. 9). Therefore, in a case where the television receiver 100 performs the master synchronization processing, the personal computer 200 performs the slave synchronization processing. Contrary to this, if the frequency of the external synchronizing signal from the personal computer 200 is faster than that of the internal synchronizing signal of the television receiver 100, the television receiver 100 performs the slave synchronization processing and the personal computer 200 performs the master synchronization processing, according to the flow chart of FIGS. 5 and 9.

In a case of the slave synchronization processing, the operation operates based on a clock operation signal synchronized with the external synchronizing signal and the phase thereof, as described above. Therefore, the display timing of the left eye image signal L and the right eye image signal R on the displays 101 and 201 synchronizes with the external synchronizing signal. Contrary to this, in a case of the master synchronization processing, the operation operates based on a clock operation signal synchronized with the internal synchronizing signal and the phase thereof, as described above. Therefore, the display timing of each of the left eye image signal L and the right eye image signal R displayed on each of the displays 101 and 201 synchronizes with the internal synchronizing signal.

Therefore, the synchronization in the display timing of each of the left eye image L and the right eye image R displayed on each of the display 101 of the television receiver 100 and the display 201 of the personal computer 200 is made. Thus, it is possible to view three-dimensional images presented by the television receiver 100 and the personal computer 200 using one pair of shutter eyeglasses 300.

In addition, by setting the television receiver 100 and the personal computer 200 in the auto mode, either the master synchronization processing or the slave synchronization processing is automatically determined by each of the devices described above, such that it is possible to save a user the trouble of the selection operation.

In addition, for example, both of the television receiver 100 and the personal computer 200 may be set to the manual mode by a user's selection operation. In this case, for example, when the television receiver 100 is determined to perform the master synchronization processing by the user's selection operation thereafter, the personal computer 200 is determined to perform the slave synchronization processing. Contrary to this, for example, when the television receiver 100 is determined to perform the slave synchronization processing by the user's selection operation thereafter, the personal computer 200 is determined to perform the master synchronization processing.

Therefore, in this case, the synchronization in the display timing of each of the left eye image L and the right eye image R displayed on each of the display 101 of the television receiver 100 and the display 201 of the personal computer 200 is made by the user's selection operation. Thus, it is possible to view three-dimensional images presented by the television receiver 100 and the personal computer 200 using one pair of shutter eyeglasses 300.

In addition, by setting the television receiver 100 and the personal computer 200 in the manual mode, a user can arbitrarily select the master synchronization processing or the slave synchronization processing in each of the devices described above.

In addition, for example, it is assumed that the television receiver 100 is set to the master mode and the personal computer 200 is set to the slave mode by a user's selection operation. In this case, the television receiver 100 is determined to perform the master synchronization processing and the personal computer 200 is determined to perform the slave synchronization processing.

Therefore, in this case, the synchronization in the display tithing of each of the left eye image L and the right eye image R displayed on each of the display 101 of the television receiver 100 and the display 201 of the personal computer 200 is made. Thus, it is possible to view three-dimensional images presented by the television receiver 100 and the personal computer 200 using one pair of shutter eyeglasses 300.

In addition, for example, it is assumed that the television receiver 100 is set to the slave mode and the personal computer 200 is set to the master mode by a user's selection operation. In this case, the television receiver 100 is determined to perform the slave synchronization processing and the personal computer 200 is determined to perform the master synchronization processing.

Therefore, in this case, the synchronization in the display timing of each of the left eye image L and the right eye image R displayed on each of the display 101 of the television receiver 100 and the display 201 of the personal computer 200 is made by the user's selection operation. Thus, it is possible to view three-dimensional images presented by the television receiver 100 and the personal computer 200 using one pair of shutter eyeglasses 300.

As described above, since an option for selecting the master mode, the slave mode, the auto mode, or the manual mode as the processing mode is provided to a user, the user can select a desired mode and can view three-dimensional images presented by the television receiver 100 and the personal computer 200 using one pair of shutter eyeglasses 300 according to the circumstance.

### 2. Modification 1

In addition, in the above-described embodiments, the television receiver 100 outputs a synchronizing signal (IR signal) representing the display timing of each of a left eye image L and a right eye image R from the IR light emitting section 102 without performing either one of the master synchronization processing or the slave synchronization processing. This can also be applied to the personal computer 200.

However, for example, when the slave synchronization processing is performed in each image display device, it may be stopped to output the synchronizing signal (IR signal) representing the display timing of each of the left eye image L and the right eye image R from the IR light emitting sections 102 and 202. In this case, the shutter eyeglasses 300 may perform the shutter operation by receiving only the synchronizing signal transmitted from the image display device performing the master synchronization processing. Therefore, malfunctions caused by the reception of the synchronizing signals transmitted from a plurality of devices may be prevented.

In addition, in the above-described embodiments, the image display observation system 10 includes two image display devices of the television receiver 100 and the personal computer 200. However, the invention may be applied to an image display observation system including three image display devices or more. In this case, for example, either one of the image display devices may be determined to perform the master synchronization processing and the other may be determined to perform the slave synchronization processing.

In addition, the invention is not limited to the above-described embodiments and various modifications and applications may occur without departing from the scope of the invention. For example, it is not limited to the television receiver 100 or the personal computer 200, and it may be various AV (Audio/Video) devices or electronic devices such as mobile phones, gaming devices, car navigations, digital photo stands or electronic books.

In addition, in the image display observation system 10 of FIG. 1, there is described a configuration example of an infrared communication type in which the television receiver 100 includes the IR light emitting section 102 and the IR light sensing section 103, the personal computer 200 includes the IR light emitting section 202 and the IR light sensing section 203, and the shutter eyeglasses 300 includes the IR light sensing section 302. As the communication type, it may adopt a radio communication type such as a radio communication type using an ISM (Industrial, Scientific and Medical use) band, for example, 2.4 GHz band.

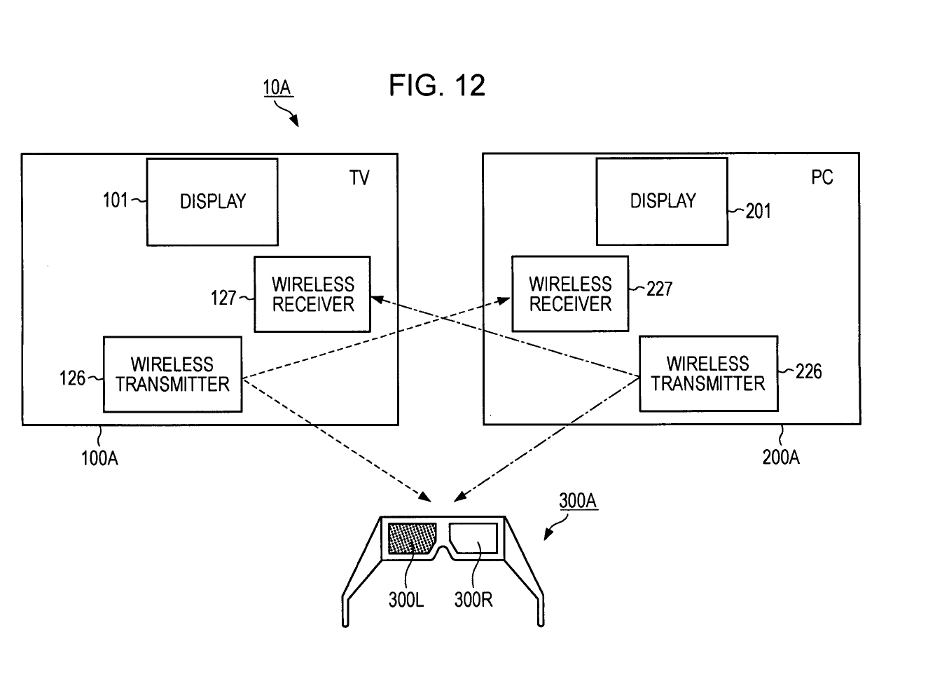

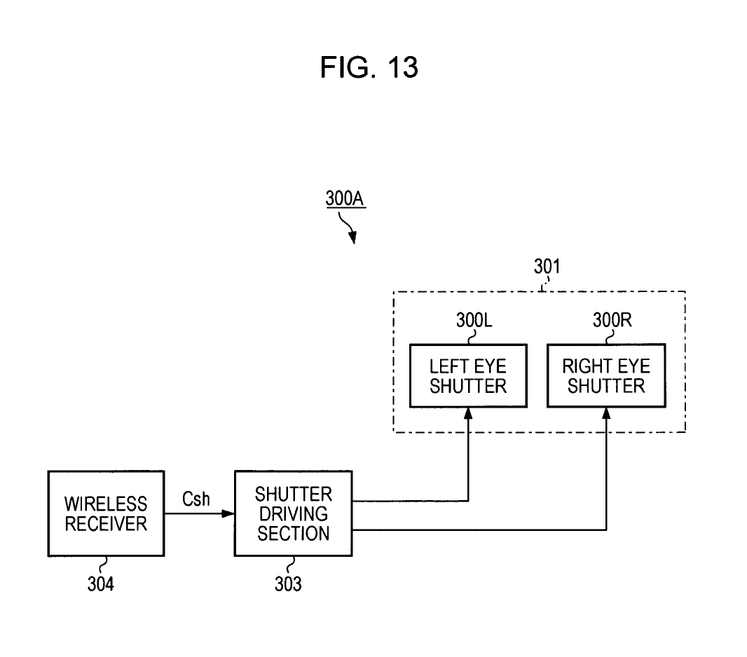

FIG. 12 shows a configuration example of an image display observation system 10A using a radio communication type. In FIG. 12, the section corresponding to that of FIG. 1 is designated by the same reference numeral. With respect to the image display observation system 10A of FIG. 12, the television receiver 100 including the IR light emitting section 102 and the IR light sensing section 103 in the image display observation system 10 of FIG. 1 is substituted with a television receiver 100A including a wireless transmitter 126 and a wireless receiver 127. In addition, with respect to the image display observation system 10A as shown in FIG. 12, the personal computer 200 including the IR light emitting section 202 and the IR light sensing section 203 in the image display observation system 10 of FIG. 1 is substituted with a personal computer 200A including a wireless transmitter 226 and a wireless receiver 227.

In addition, with respect to the image display observation system 10A of FIG. 12, the shutter eyeglasses 300 in the image display observation system 10 of FIG. 1 is substituted with shutter eyeglasses 300A. FIG. 13 shows a configuration example of the shutter eyeglasses 300A using a radio communication type. In FIG. 13, the section corresponding to that of FIG. 11 is designated by the same reference numeral. With respect to the shutter eyeglasses 300A of FIG. 13, the IR light sensing section 302 in the shutter eyeglasses 300 of FIG. 11 is substituted with a wireless receiver 304.

In addition, as the image display observation system, it is not limited to a configuration using only either one of the above-described IR communication type and the above-described radio communication type, a configuration in which each device is provided with the two communication types and either one of the two communication types is used selectively in a suitable manner may be conceivable. The above-described configuration using two communication types is disclosed, for example, in Japanese Unexamined Patent Application Publication No. 2009-65241.

### 3. Modification 2

In addition, in the above-described embodiments, the television receiver 100 will not necessarily be the same as the personal computer 200 in the display capacity of the display thereof. For example, it is assumed that the maximum frame rate capable of being displayed by the television receiver 100 is 240 frames/second and the maximum frame rate capable of being displayed by the personal computer 200 is 120 frames/second.

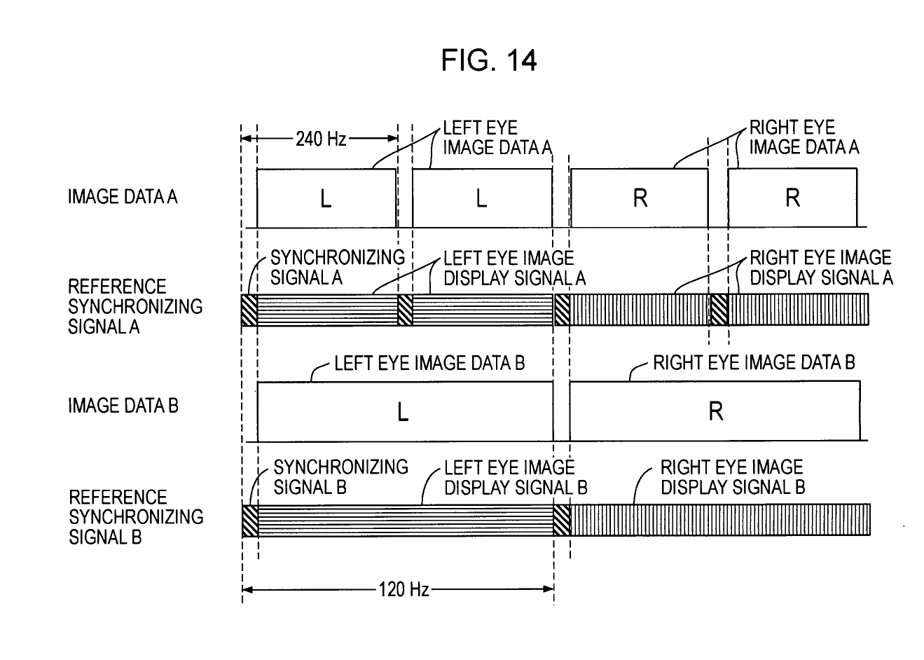

It is assumed that, by a user's setting, the television receiver 100 is set to a master mode and therefore is determined to perform a master synchronization processing, and the personal computer 200 is set to a slave mode and therefore is determined to perform a slave synchronization processing. An example of the timing of each of the left eye image data and the right eye image data displayed on the display 101 of the television receiver 100 and each reference synchronizing signal thereof is shown in FIG. 14.

Image data A includes left eye image data A and the right eye image data A displayed on the display 101. The reference synchronization signal A has a synchronizing signal A representing a synchronization timing (a frame rate or the like) or a signal format, a left eye image display signal A that controls the display timing of the left eye image data on the display 101, and a right eye image display signal A that controls the display timing of the right eye image data on the display 101.

In this case, the frame rate of the synchronizing signal A is 240 frames/second and the image driving section 116 displays the left eye image data A on the display 101 at a timing based on the synchronizing signal A and the left eye image display signal A. The image driving section 116 displays the right eye image data A on the display 101 at a timing based on the synchronizing signal A and the right eye image display signal A. In addition, the synchronizing signal output controller 121 outputs an IR signal based on the reference synchronizing signal A via the IR light emitting section 102.

When the IR light sensing section 203 and the external synchronization controller 222 of the personal computer 200 receive an IR signal based on the reference synchronizing signal A (240 frames/second) output from the IR light emitting section 102 of the television receiver 100, the received signal is input to the resolution determining section 231 and the switch section 232 of the synchronizing signal processing section 223 as an external synchronizing signal. The resolution determining section 231 determines the external synchronizing signal and the determination signal thereof is informed to the CPU 204. The CPU 204 detects that the frame rate of the external synchronizing signal is 240 frames/second.

Even though the personal computer 200 is set to the slave synchronization processing, since the external synchronizing signal is over the maximum frame rate capable of being displayed by the personal computer 200, the reference synchronizing signal adjusting section 233 provided to the synchronizing signal processing section 223 generates a reference synchronizing signal capable of being displayed by the personal computer 200 from the external synchronizing signal. For example, an example of the reference synchronizing signal generated by the reference synchronizing signal adjusting section 233 is shown as the reference synchronizing signal B of FIG. 14.

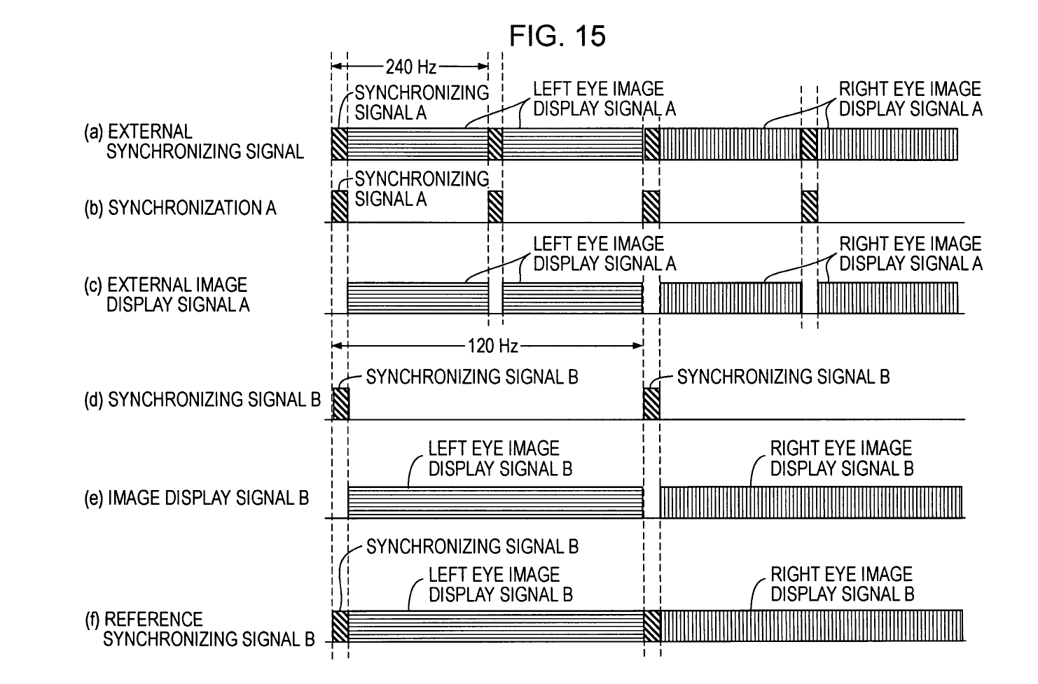

An example of a timing chart where the reference synchronizing signal adjusting section 233 generates the reference synchronizing signal B from the external synchronizing signal is shown in FIG. 15. First, the reference synchronizing signal adjusting section 233 separates a synchronizing signal A ((b) of FIG. 15) and an external image display signal A ((c) of FIG. 15) from the external synchronizing signal ((a) of FIG. 15). The reference synchronizing signal adjusting section 233 performs a frequency dividing process with respect to the separated synchronizing signal A ((b) of FIG. 15) to generate a synchronizing signal B ((d) of FIG. 15) synchronized with the synchronizing signal A in a frame rate of 120 frames/second.

In addition, from the separated external image display signal A ((c) of FIG. 15), an image display signal B ((e) of FIG. 15) synchronized with the synchronizing signal B in which a left eye image display signal B and a right eye image display signal B are inserted within one cycle interval of the synchronizing signal is generated. The reference synchronizing signal adjusting section 233 synthesizes the synchronizing signal B ((d) of FIG. 15) and the image display signal B ((e) of FIG. 15) to generate a reference synchronizing signal B ((f) of FIG. 15) and outputs the generated signal. Then, the reference synchronizing signal B is used as the reference synchronizing signal of the personal computer 200.

The operation clock signal generating section 224 generates an operation signal synchronized with the phase of the reference synchronizing signal B. Therefore, the image processing section 214, the frame synchronizer 215, the image driving section 216, or the like operates based on the reference synchronizing signal B and the operation clock signal synchronized with the phase of the reference synchronizing signal B. Therefore, the display timing of each of the left eye image (left eye image data B of FIG. 14) and the right eye image (right eye image data B of FIG. 14) on the display 201 synchronizes with the reference synchronizing signal B.

Specifically, in the display 201, the left eye image data B is displayed based on the display timing of the left eye image display signal B of the reference synchronizing signal B, and the right eye image data B is displayed based on the display timing of the right eye image display signal B of the reference synchronizing signal B. In addition, the external synchronizing signal and the reference synchronizing signal B are different from each other, such that for the prevention of the malfunction of the television receiver 100 and the shutter eyeglasses 300, the output of the IR signal from the IR light emitting section 202 is stopped based on the reference synchronizing signal B.

On the other hand, the shutter eyeglasses 300 receives an IR signal based on the reference synchronizing signal A transmitted from the television receiver 100, as a shutter control signal Csh. Although detailed description will be omitted, in the shutter eyeglasses 300, a left eye shutter 300L opens based on the display timing of the left eye image display signal A of the reference synchronizing signal A and a right eye shutter 300R opens based on the display timing of the right eye image display signal A of the reference synchronizing signal A.

The shutter eyeglasses 300 operates as described above, such that a viewer wearing the shutter eyeglasses 300 can only perceive the left eye image (left eye image data B) with the left eye and can only perceive the right eye image (right eye image data B) with the right eye with respect to the display 201 of the personal computer 200. In addition, the viewer wearing the shutter eyeglasses 300 can only perceive the left eye image (left eye image data A) with the left eye and can only perceive the right eye image (right eye image data A) with the right eye with respect to the display 101 of the television receiver 100. Therefore, the viewer can perceive a three-dimensional color image based on the left eye image L and the right eye image R, which have parallax therebetween.

The present application contains subject matter related to that disclosed in Japanese Priority Patent Application JP 2010-051414 filed in the Japan Patent Office on Mar. 9, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image display device, comprising:
an image display section;
a display controller that alternately displays a left eye image and a right eye image, which have parallax therebetween, on the image display section;
a synchronizing signal generating section that generates a synchronizing signal indicating a display timing of each of the left eye image and the right eye image on the image display section, as an internal synchronizing signal;
a synchronizing signal receiver that receives a synchronizing signal indicating the display timing of each of the left eye image and the right eye image output from another image display device, as an external synchronizing signal; and
a synchronizing signal selecting section that selects either the external synchronizing signal or the internal synchronizing signal output from the synchronizing signal generating section, as a reference synchronizing signal, when the synchronizing signal receiver receives the external synchronizing signal,
wherein the display controller alternately displays the left eye image and the right eye image on the image display section at a display timing based on the reference synchronizing signal selected in the synchronizing signal selecting section.

2. The image display device according to claim 1,
wherein the synchronizing signal selecting section determines each of a frequency and a signal format based on the external synchronizing signal and the internal synchronizing signal, and selects the external synchronizing signal as the reference synchronizing signal, in a case where the frequency and the signal format based on the external synchronizing signal are faster than the frequency and the signal format based on the internal synchronizing signal, and
the synchronizing signal selecting section selects either the external synchronizing signal or the internal synchronizing signal as the reference synchronizing signal, in a case where the frequency and the signal format based on the external synchronizing signal are equal to the frequency and the signal format based on the internal synchronizing signal, and selects the internal synchronizing signal as the reference synchronizing signal in all other cases.

3. The image display device according to claim 1,
wherein the synchronizing signal selecting section selects either the external synchronizing signal or the internal synchronizing signal as the reference synchronizing signal based on an acquisition state of the external synchronizing signal when the powder is switched ON or a user's selection operation.

4. The image display device according to claim 1, further comprising:
a user setting section that selectively sets a master mode, a slave mode, an auto mode, or a manual mode,
wherein the synchronizing signal selecting selection selects the internal synchronizing signal as the reference synchronizing signal when the master mode is selected by the user setting section,
the synchronizing signal selecting section selects the external synchronizing signal as the reference synchronizing signal when the slave mode is selected by the user setting section,
when the auto mode is selected by the user setting section, the synchronizing signal selecting section determines each of the frequency and the signal format based on the external synchronizing signal and the internal synchronizing signal and selects the external synchronizing signal as the reference synchronizing signal, in a case where the frequency and the signal format based on the external synchronizing signal are faster than the frequency and the signal format based on the internal synchronizing signal, and the synchronizing signal selecting section selects either the external synchronizing signal or the internal synchronizing signal as the reference synchronizing signal, in a case where the frequency and the signal format based on the external synchronizing signal are equal to the frequency and the signal format based on the internal synchronizing signal and selects the internal synchronizing signal as the reference synchronizing signal in all other cases, and
the synchronizing signal selecting section selects either the external synchronizing signal or the internal synchronizing signal according to the user's selection operation, when the manual mode is selected by the user setting section.

5. The image display device according to claim 1, further comprising:
a synchronizing signal transmitter that generates a synchronizing signal for transmission based on the internal synchronizing signal or the reference synchronizing signal selected by the synchronizing signal selecting section and transmits the synchronizing signal for transmission to another image display device and a three-dimensional image observing shutter eyeglasses.

6. The image display device according to claim 5,
wherein the synchronizing signal transmitter stops the transmission of the synchronizing signal when the external synchronizing signal is selected as the reference synchronizing signal by the synchronizing signal selecting section.

7. The image display device according to claim 1,
wherein the synchronizing signal selecting section determines each of the frequency and the signal format based on the external synchronizing signal and the internal synchronizing signal, synchronizes with the display timing based on the reference synchronizing signal when the frequency and the signal format based on the reference synchronizing signal selected from the external synchronizing signal or the internal synchronizing signal are not a frequency and a signal format capable of being displayed on the image display section, converts or adjusts the frequency and the signal format of the reference synchronizing signal to be a frequency and a signal format capable of being displayed on the image display section, and outputs the converted or adjusted reference synchronizing signal.

8. The image display device according to claim 1, further comprising:
an image processing section that inputs the left eye image signal and the right eye image signal,
wherein the image processing section performs a conversion processing of a signal format based on the reference synchronizing signal with respect to the left eye image signal and the right eye image signal that are input, and
the image processing section synchronizes the left eye image signal and the right eye image signal after the conversion processing, with the display timing based on the synchronizing signal and outputs the synchronized signals to the display controller.

9. The image display device according to claim 1,
wherein a communication type of the synchronizing signal receiver is either one of an infrared (IR) communication type or a radio communication type.

10. The image display device according to claim 5,
wherein a communication type of the synchronizing signal transmitter is either one of an IR communication type or a radio communication type.

11. A method of displaying an image, comprising the steps of:
displaying alternately a left eye image and a right eye image', which have parallax therebetween, on a display section;
generating a synchronizing signal indicating a display timing of each of the left eye image and the right eye image on the image display section, as an internal synchronizing signal;
receiving a synchronizing signal indicating a display timing of each of a left eye image and a right eye image output from another image display device, as an external synchronizing signal;
selecting either one of the external synchronizing signal and the internal synchronizing signal generated in the generating of a synchronizing signal as a reference synchronizing signal, when the external synchronizing signal is received in the receiving of a synchronizing signal,
wherein, in the displaying of a left eye image and right eye image, the left eye image and the right eye image are alternately displayed on the image display section at a display timing based on the reference synchronizing signal selected in the selecting of a synchronizing signal.
